(19) United States
(12) Patent Application Publication
(10) Pub. No.: US 2024/0042640 A1
(43) Pub. Date: Feb. 8, 2024

(54) Methods and Apparatuses for Material Cutting

(71) Applicant: Perry Kaye, Cooper City, FL (US)

(72) Inventor: Perry Kaye, Cooper City, FL (US)

(21) Appl. No.: 18/488,031

(22) Filed: Oct. 16, 2023

Related U.S. Application Data
(63) Continuation-in-part of application No. 16/970,617, filed on Aug. 17, 2020, now abandoned.

(51) Int. Cl. B26B 27/00

(52) U.S. Cl. CPC B26B 27/00; B26B 29/06

(57) ABSTRACT

A portable, non-invasive, multipurpose cutting device requiring minimal manual manipulation. The device has a handle, a bearing, a base, and a blade in various concentric configurations with bearings. The device is moved with a finger to push and pull the device while the device base rotates independently of the device handle. The device makes cutting material precise, easy, and fun. Guides and accessories make the device appealing and interactive.

### PRIORITY CLAIM

This application is a continuation-in-part of U.S. non-provisional application Ser. No. 16/970,617 having a filing date of Aug. 17, 2020, entitled the same, and which was a national stage application of PCT/US18/18454, entitled Methods and Apparatuses for Material Cutting, having a filing date of Feb. 15, 2018, and which claims priority to US provisional application number 62,459,571, filed on Feb. 15, 2017, all of which are incorporated by reference.

### FIELD OF THE DISCLOSURE

The present disclosure relates to methods and apparatuses for material cutting. More specifically, the present disclosure presents a portable, non-invasive, multipurpose cutting device requiring minimal manual manipulation.

### BACKGROUND OF THE DISCLOSURE

Tablet computers and portable electronic devices are popular for generating digital art. A person typically uses a touch-screen device with peripherals such as a stylus, mouse, trackpad, joystick, rollerball, keyboard, game controller, matrix mousepad, or a dial such as the popular type used with the Microsoft Surface devices. The peripheral connects and communicates with the digital device such as a computer or a tablet. A person may also simply create digital art by using his/her fingers.

Many people turn to such digital options because they are relatively simple and offer more precision, especially for more delicate and intricate projects. People have become more accustomed to performing these digital artistic tasks such as manipulating a Surface Dial or joystick to create art on screen.

Due to the increase in use of digital art implements, people have become accustomed to utilizing fine motor skills and smaller movements to create art. For example, the old-fashioned way to create a paper snowflake is to fold the paper, grab scissors, and use the entire hand to manipulate the scissors to attempt to make small cuts in the paper. This is neither easy nor precise.

### SUMMARY OF THE DISCLOSURE

What is needed are methods and apparatuses for material cutting that allows a user to accurately and precisely cut through material. A user moves the apparatus along a surface to cut shapes and patterns. The apparatus can be formed in both large and small, fingertip-sized configurations. The apparatus can be configured with guides, accessories, and various blade configurations. A basic apparatus comprises a handle, at least one bearing, and a base.

In one embodiment, the device has a handle concentrically inserted through a core of a bearing which is inserted into an aperture of a base. The base houses an integrated thrust bearing. The base rotates independently of the handle.

### BRIEF DESCRIPTION OF THE DRAWINGS

The accompanying drawings illustrate several embodiments of the disclosure and, together with the description, serve to explain the principles of the disclosure.

FIG. 1 shows an exploded view of an exemplary apparatus for material cutting.

FIG. 2 shows a side sectional view of an exemplary apparatus for material cutting.

FIG. 3 shows a perspective view of an exemplary apparatus for material cutting.

FIG. 4 shows an exploded view of an exemplary apparatus for material cutting.

FIG. 5a shows a perspective view of an exemplary apparatus for material cutting.

FIG. 5b shows a side sectional view of an exemplary apparatus for material cutting.

FIG. 6 shows a perspective view of a person using an exemplary apparatus for material cutting.

### REFERENCE NUMERALS OF THE DRAWINGS

1 Device
2. Handle external portion
3 Proximal end
5 Distal end
9 Handle internal portion
11 Handle
13 Roller Bearing
15 Base
17 Indentations
19 Core
21 Base aperture
23 Base side
25 Base inner surface
28 Blade shaft
29 Guide indicator
31 Skid
33 Blade
34. Thrust Bearing
35 Protruding arrow
37 Protruding foot
39 Blade fastener
43 Control object
45 Surface
47 Device accessory

### DETAILED DESCRIPTION

The present disclosure provides generally for methods and apparatuses for material cutting. According to the present disclosure, a device generally comprises a rotational base, a non-rotational handle, a roller bearing, a thrust bearing, and a blade. A device may also include accessories. A device may be used to cut material. A base is at the distal end of the device is may be applied to the surface. A handle is at the proximal end of the device and may accommodate a person's finger.

A device may be controlled by a single fingertip, multiple fingertips, or by grasping with a hand. A device may also be controlled by a foot, toe, nose, tongue, elbow, knuckle, or a separate device complementary to a handle. A handle may have indentations, varying shapes, and varying textures to accommodate the part of a person or object applied to the handle to control the device.

A device may be used by placing a base on material, placing a finger on a handle, applying pressure, and applying push force or applying pull force. A user may change the direction in which a device travels by flexing, extending, and rotating the finger while the fingertip is placed on the handle. Bearings allow for the base to independently rotate from the handle, so that the blade direction will substantially correlate with the direction of the push or pull forces applied to the device.

The movements a person uses to control a device may be similar to the movements used with digital peripheral devices. The device moves about the surface of the material. A combination of gravity, pressure, push forces, rotation, drag, and friction cause the device blade to cut the material. Cutting the material is substantially independent of velocity. In other words, the device may cut material substantially independently from changes in velocity during normal and expected use of the device.

In the following sections, detailed descriptions of examples and methods of the disclosure will be given. The description of both preferred and alternative examples are exemplary only, and it is understood that to those skilled in the art that variations, modifications, and alterations may be apparent. It is therefore to be understood that the examples do not limit the broadness of the aspects of the underlying disclosure as defined by the claims.

### Glossary

“device” as used herein means a material cutting apparatus.
“material” as used herein means a surface that can be cut.
“blade” as used herein means any object with a sharp edge or point.
“control object” as used herein means a fingertip, hand, foot, toe, nose, elbow, pencil, pen, stick, handle add-on, accessory, or anything that can be accommodated by a handle and can be used to exert push forces or pull forces on the device.

“guide indicator” as used herein means an arrow, shape, image, texture, protrusion, color, or any other indicator that aids in orienting the parson, guiding the cutting path, and aligning the device.

### DETAILED DESCRIPTIONS OF THE DRAWINGS

Devices may be modular, have some parts fixedly combined as a single assembly, or may be completely fixedly combined into a single assembly.

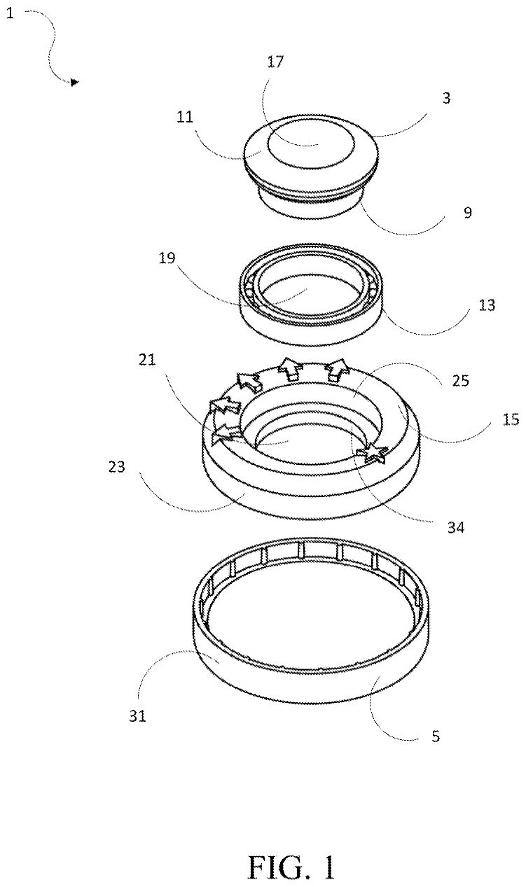

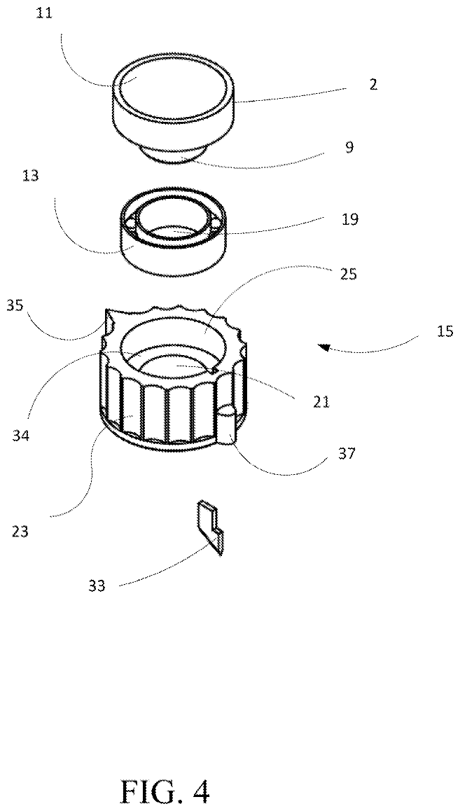

Referring to FIG. 1, an exploded view of an exemplary apparatus for material cutting is shown. The device 1 is shown having a proximal end 3 and a distal end 5. A handle 11 is shown with an indentation 17. A roller bearing 13 is shown with a core 19. A base 15 is shown having a base inner surface 25, a base side 23, a base aperture or inner base space 21. The device may contain a rotational base 7 and a non-rotational handle 9. a handle at a proximal end of the cutting device, wherein the handle comprises a wide handle external portion and a narrow handle internal portion, a roller bearing having a core, a base comprising a base aperture, a base inner surface, a blade shaft containing a blade fixed to a thrust bearing, and a base side, and a skid at a distal end of the cutting device. The narrow handle internal portion concentrically fits into the roller bearing core. The roller bearing concentrically fits into the base aperture and lies against the base inner surface. The base rotates independently of the handle when a force is applied to the handle. The device may contain a second, bottom, or thrust bearing 34 integrated into the base as shown in FIG. 4.

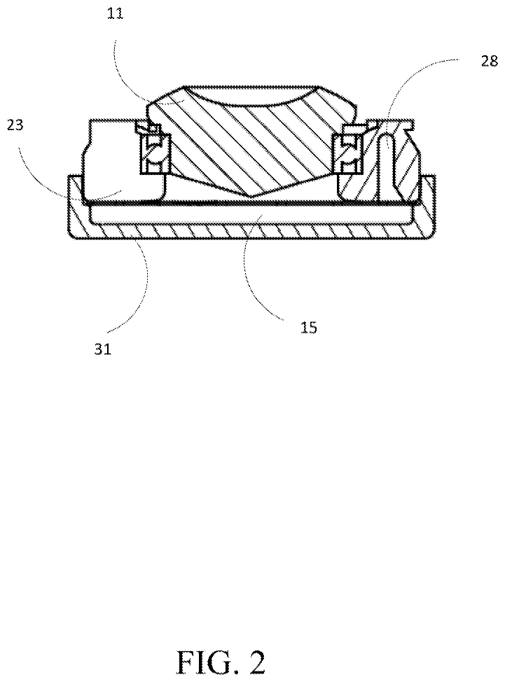

Referring to FIG. 2, a side sectional view of an exemplary apparatus for material cutting is shown. The device 1 may be configured with a handle 11, bearing 13, and a blade shaft 28.

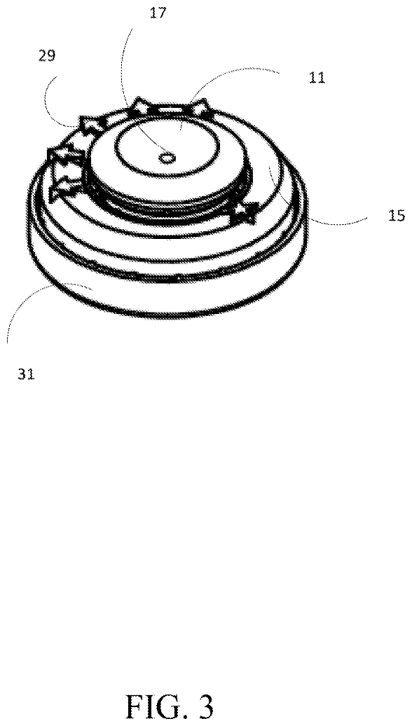

Referring to FIG. 3, a perspective view of an exemplary apparatus for material cutting is shown. The device may be configured with a skid 31, guide indicator 29, handle 11 with an indentation 17, a base 15, and at least one bearing 13.

Referring to FIG. 4, an exploded view of an exemplary embodiment of an apparatus for material cutting or cutting device is shown. A device may be configured in a smaller form approximately the circumference of a finger and may comprise a handle 11 with a bearing 13, a base 15, a protruding arrow 35, a blade 33, and at least one protruding foot 37. The handle has a

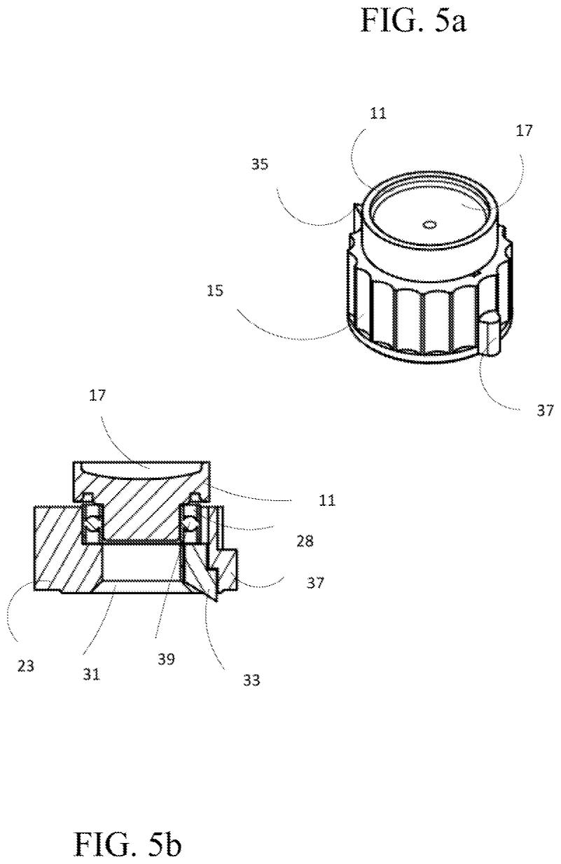

Referring to FIGS. 5a and 5b, a perspective view and a side sectional view are shown respectively. An exemplary device may be configured with a base side 23, skid 31, a blade fastener 39, a blade 33, a protruding foot 37, a blade shaft 28, and a handle 11 with an indentation 17 suitable for accommodating a finger. Some embodiments may further comprise a protruding arrow 35. The blade fastener, such as a screw or a pin, connects or attaches the blade to the thrust bearing. In preferred embodiments, the base houses the thrust bearing and blade shaft containing the blade. The protruding foot of the base houses the blade shaft in which the blade is housed and connected to the thrust bearing.

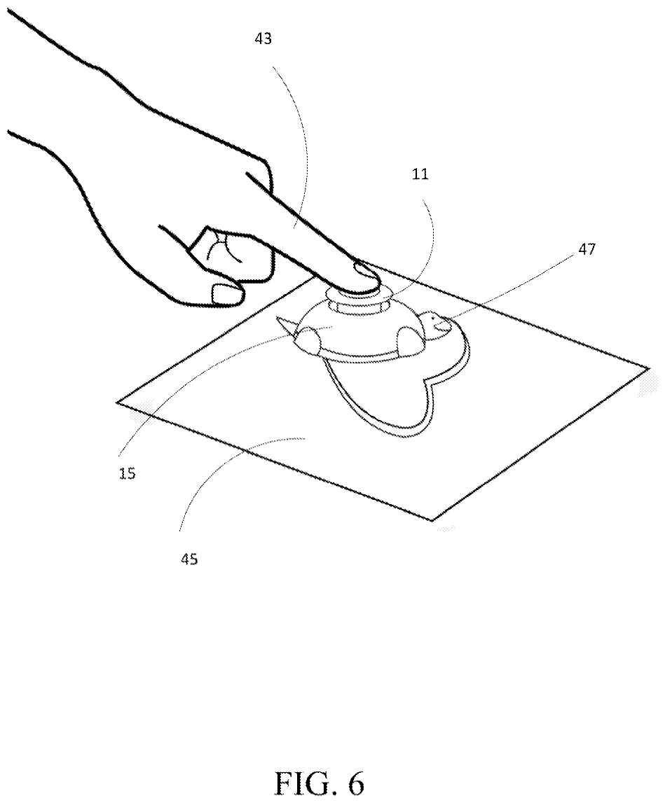

Referring to FIG. 6, an exemplary embodiment of a person using the device with an accessory is shown. A control object 43 such as a finger is placed on a handle connected to a base having a handle accessory 47 such as an exterior shell or housing applied on or to the base. A handle accessory can have structures resembling characters or animals. The device distal end is applied to a surface 45 for cutting. Accessories may snap on to a handle. Exemplary functional accessories are shown such as an arrow or a magnifier that snap onto the sides of the handle.

Accessories may be fixably or removably attached to a base, a handle, or both. An accessory may be functional or decorative. A functional accessory may be a magnifier or an arrow. A decorative accessory may be a flower or a character. An accessory may wrap or snap about the outer edges of the handle, the base, or both. An accessory may be a handle add-on and vice versa. A handle add-on may be a nob, like a joystick. Accessories may be interchangeable.

In some embodiments, a device may have a handle with a core that fits concentrically through a bearing. The bearing with the handle fits concentrically inside the aperture of a base. The base may have sculpted sides, a protruding arrow, and protruding feet. The base may have an offset blade fastener and blade position.

In another embodiment, a device may have a handle with a bearing that frictionally fits in the handle aperture. The device may have a base that is wider than the handle and has a center core protrusion that concentrically fits inside a bearing. The base may have sculpted edges and an arrow guide indicator. The base may contain a blade fastener and blade spanning from the thrust bearing to the distal end of the base.

An alternative embodiment of a device may contain a handle with a bearing frictionally fit concentrically inside the base aperture. The base may contain an aperture, blade fastener, and blade covered by a protruding foot at a side of the base. The base may have smooth, rounded edges and taper toward the base aperture.

An exemplary device may contain two protrusions and one blade fastener and blade. In this embodiment, the base has a greater circumference than the handle. A device can have any number of protrusions, textures, depressions, cut-outs, blade fasteners, and blades. The bottom image, FIG. 5b, shows the handle of an exemplary device. The handle contains a central depression to accommodate a control object. The top image, FIG. 5a, shows an exemplary device where part of the base is shown having a protruding foot and a protruding arrow.

Exemplary embodiments may have various configurations with the handle, blade fastener, and blade positions. A device handle may be concentrically inserted into a base. A blade fastener may be integrated with the handle. The blade fastener and blade may be substantially in the center of the device. In another configuration, a base contains a bearing, and a handle is inserted concentrically into the hollow of the base. The base may be wider than the handle. A blade fastener and blade may be present at the outer part of the base. The blade may not be aligned in the center and is substantially offset instead. In another configuration, a device may have a base that is concentrically inserted inside the base aperture.

In some embodiments, a device comprises a handle, a bearing, a blade fastener, an arrow, a skid, and a blade. An arrow may be an accessory or formed as part of the base or the blade fastener. The arrow may be used to indicate to a person in which direction to apply push forces. In some embodiments, a blade with a diagonal, triangular, or chiseled tip may be placed at the opposite end of a base with the hypotenuse end facing away from the device. Drag and rudder-type forces may be facilitated by applying pushing or pulling forces with or by a control object such as a finger and will guide the cutting path of the blade to match the direction of the arrow. If a person applies force in a different direction, the base with blade fastener and blade will rotate independently from the stationary handle to maintain the directional relationship between the arrow and the blade tip.

In some embodiments, a blade shaft may be attached to a top bearing. In some embodiments, a blade may be attached to a bottom bearing. In some embodiments, a handle may be attached to a top bearing. A skid may be attached to a bottom bearing or to a base. A blade and a blade shaft may fixably or removably accommodate a handle and a skid. In some embodiments, a blade and a blade shaft or a blade fastener may be one assembly.

A device may also be without a blade. Blades may be changeable. Blades may also have various configurations pertaining to angle and depth. Blades may in in a safety configuration or may be in an aggressive configuration. A safety configuration may have the blade protruding approximately from 1 to approximately 5 millimeters. An aggressive configuration may have the blade protruding from approximately 3 to approximately 10 millimeters.

A device may have various bearing such as a roller bearing, a radial bearing, or a thrust bearing. In some embodiments, the blade may be fixably or removably attached to a thrust bearing. A bearing or a base may have a partial conic shape with a central button or saddle at the center of gravity to improve aesthetics, improve rotation and orientation, and provide a better view of the material to be cut. Some embodiments may contain a magnet.

### CONCLUSION

Although the disclosure has been described in terms of exemplary embodiments, the disclosure is not limited thereto. This description of the exemplary embodiments is set to be understood in connection with the figures of the accompanying drawings, which are to be considered part of the entire written description. Relative terms such as “lower,” “upper,” “horizontal,” “vertical,” “above,” “below,” “up,” “down,” “top,” “bottom,” “back,” and “front” as well as derivatives such as “horizontally,” “downwardly,” and “upwardly,” should be construed to refer to the orientation as then described or as shown in the particular figure under discussion. These relative terms are for convenience of description and do not require that the probe head be constructed or operated in a particular orientation. Terms concerning attachments and coupling such as “connected” refer to a relationship wherein structures are secured or attached to one another either directly or indirectly through intervening structures, as well as both movable or rigid attachments or relationships, unless expressly described otherwise.

While this specification contains many specific implementation details, these details should not be construed as limitations on the scope of any disclosures or of what may be claimed. It should be understood that these exemplary embodiments may be susceptible to various modifications and may present in alternative forms. All statements herein reciting principles, aspects, and embodiments of the disclosure are intended to encompass both the structural and the functional equivalents thereof. Additionally, it is intended that such equivalents include both currently known equivalents and any elements developed in the future that perform the same function regardless of structure. The claims are not intended to be limited to the particular embodiments, modifications, and alternative forms disclosed but are intended to cover all modifications, equivalents, and alternatives falling within the spirit and scope of the disclosure.

What is claimed is:

1. A cutting device, comprising:
a handle at a proximal end of the cutting device, wherein the handle comprises a wide handle external portion and a narrow handle internal portion,
a roller bearing having a core,
a base comprising a base aperture, a base inner surface, a blade shaft containing a blade fixed to a thrust bearing, and a base side, and
a skid at a distal end of the cutting device;
wherein the narrow handle internal portion concentrically fits into the roller bearing core,
wherein, the roller bearing concentrically fits into the base aperture and lies against the base inner surface; and
wherein the base rotates independently of the handle when a force is applied to the handle.

2. The device of claim 1 wherein the force applied is a pushing force.

3. The device of claim 1 wherein the force applied is a pulling force.

4. The device of claim 1 wherein the handle further comprises an indentation.

5. The device of claim 1 wherein the base further comprises a protruding foot housing the blade shaft.

6. The device of claim 1 further comprising the blade engaging with a surface and cutting the surface when a pushing force is applied to the handle.
